(19) United States
(12) Patent Application Publication
(10) Pub. No.: US 2024/0031361 A1
(43) Pub. Date: Jan. 25, 2024

(54) Authentication System and Method

(71) Applicant: NFTy Lock, LLC, Enoch, UT (US)

(72) Inventor: Ronald E. Lynch, II, Johnson City, TX (US)

(21) Appl. No.: 18/357,614

(22) Filed: Jul. 24, 2023

Related U.S. Application Data
(60) Provisional application No. 63/391,529, filed on Jul. 22, 2022.

(51) Int. Cl. H04L 9/40

(52) U.S. Cl. CPC H04L 63/0861; H04L 63/083

(57) ABSTRACT

A computer-implemented method, computer program product and computing system for processing an original genetic sequence sample to generate a digital representation of at least a portion of the original genetic sequence sample, wherein the digital representation includes: a public digital portion and a private digital portion that have a common overlapping portion; enabling the use of the public digital portion on an online ledger to define ownership of an asset; and enabling a user to confidentially maintain the private digital portion.

### RELATED APPLICATION(S)

This application claims the benefit of U.S. Provisional Application No. 63/391,529, filed on 22 Jul. 2022, the entire contents of which are incorporated herein by reference.

### TECHNICAL FIELD

This disclosure relates to authentication systems and, more particularly, to authentication systems that enable the use of non-fungible tokens.

### BACKGROUND

Blockchain began with the conceptual groundwork laid by cryptographers and computer scientists seeking to create decentralized and secure systems for digital transactions. However, the breakthrough moment occurred in 2008 when an individual or group using the pseudonym Satoshi Nakamoto published a whitepaper titled “Bitcoin: A Peer-to-Peer Electronic Cash System.” This groundbreaking paper introduced Bitcoin, the first decentralized cryptocurrency, and its underlying technology: blockchain. In January 2009, Nakamoto mined the first-ever block of the Bitcoin blockchain, known as the “genesis block,” marking the official launch of the network.

Blockchain revolutionized digital transactions by offering a decentralized and tamper-proof ledger that eliminated the need for intermediaries like banks. As the popularity of Bitcoin and blockchain technology grew, developers began exploring its potential for applications beyond cryptocurrencies. They introduced smart contracts, self-executing contracts with predefined conditions written into code, opening doors to decentralized applications (dApps) and programmable blockchain platforms like Ethereum.

Today, blockchain technology is widely recognized for its potential to transform various industries, including finance, supply chain management, healthcare, and more, by providing transparency, security, and efficiency in a trustless environment. The continuous evolution of blockchain technology promises even more innovative solutions and disruption in the digital age.

### Summary of Disclosure

In one implementation, a computer-implemented method is executed on a computing device and includes: processing an original genetic sequence sample to generate a digital representation of at least a portion of the original genetic sequence sample, wherein the digital representation includes: a public digital portion and a private digital portion that have a common overlapping portion; enabling the use of the public digital portion on an online ledger to define ownership of an asset; and enabling a user to confidentially maintain the private digital portion.

One or more of the following features may be included. In the event of an inquiry and/or transaction concerning the asset, the private digital portion may be utilized to authenticate the ownership of the asset by the user. Utilizing the private digital portion to authenticate the ownership of the asset by the user may include one or more of: confirming that the public digital portion and the private digital portion each include the common overlapping portion; and confirming that the public digital portion and the private digital portion combine to form the digital representation of the at least a portion of the original genetic sequence sample. The inquiry and/or transaction may be allowed to occur if the ownership of the asset is authenticated. The inquiry and/or transaction may be prohibited from occurring if the ownership of the asset cannot be authenticated. The public digital portion may be defined within a first non-fungible token. The private digital portion may be defined within a second non-fungible token. The online ledger may include a distributed blockchain ledger. The asset may include one or more of: a digital asset; a virtual asset; and a physical asset. The private digital portion may be regenerated if the private digital portion is no longer available. Regenerating the private digital portion if the private digital portion is no longer available may include processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample. The original genetic sequence sample may include one or more of: a DNA sample; and an RNA sample. The DNA sample may include one or more of: a real DNA sample; a synthetic DNA sample; and an imaginary DNA sample.

In another implementation, a computer program product resides on a computer readable medium and has a plurality of instructions stored on it. When executed by a processor, the instructions cause the processor to perform operations including processing an original genetic sequence sample to generate a digital representation of at least a portion of the original genetic sequence sample, wherein the digital representation includes: a public digital portion and a private digital portion that have a common overlapping portion; enabling the use of the public digital portion on an online ledger to define ownership of an asset; and enabling a user to confidentially maintain the private digital portion.

One or more of the following features may be included. In the event of an inquiry and/or transaction concerning the asset, the private digital portion may be utilized to authenticate the ownership of the asset by the user. Utilizing the private digital portion to authenticate the ownership of the asset by the user may include one or more of: confirming that the public digital portion and the private digital portion each include the common overlapping portion; and confirming that the public digital portion and the private digital portion combine to form the digital representation of the at least a portion of the original genetic sequence sample. The inquiry and/or transaction may be allowed to occur if the ownership of the asset is authenticated. The inquiry and/or transaction may be prohibited from occurring if the ownership of the asset cannot be authenticated. The public digital portion may be defined within a first non-fungible token. The private digital portion may be defined within a second non-fungible token. The online ledger may include a distributed blockchain ledger. The asset may include one or more of: a digital asset; a virtual asset; and a physical asset. The private digital portion may be regenerated if the private digital portion is no longer available. Regenerating the private digital portion if the private digital portion is no longer available may include processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample. The original genetic sequence sample may include one or more of: a DNA sample; and an RNA sample. The DNA sample may include one or more of: a real DNA sample; a synthetic DNA sample; and an imaginary DNA sample.

In another implementation, a computing system includes a processor and a memory system configured to perform operations including processing an original genetic sequence sample to generate a digital representation of at least a portion of the original genetic sequence sample, wherein the digital representation includes: a public digital portion and a private digital portion that have a common overlapping portion; enabling the use of the public digital portion on an online ledger to define ownership of an asset; and enabling a user to confidentially maintain the private digital portion.

One or more of the following features may be included. In the event of an inquiry and/or transaction concerning the asset, the private digital portion may be utilized to authenticate the ownership of the asset by the user. Utilizing the private digital portion to authenticate the ownership of the asset by the user may include one or more of: confirming that the public digital portion and the private digital portion each include the common overlapping portion; and confirming that the public digital portion and the private digital portion combine to form the digital representation of the at least a portion of the original genetic sequence sample. The inquiry and/or transaction may be allowed to occur if the ownership of the asset is authenticated. The inquiry and/or transaction may be prohibited from occurring if the ownership of the asset cannot be authenticated. The public digital portion may be defined within a first non-fungible token. The private digital portion may be defined within a second non-fungible token. The online ledger may include a distributed blockchain ledger. The asset may include one or more of: a digital asset; a virtual asset; and a physical asset. The private digital portion may be regenerated if the private digital portion is no longer available. Regenerating the private digital portion if the private digital portion is no longer available may include processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample. The original genetic sequence sample may include one or more of: a DNA sample; and an RNA sample. The DNA sample may include one or more of: a real DNA sample; a synthetic DNA sample; and an imaginary DNA sample.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a authentication process according to an embodiment of the present disclosure; and

FIG. 2 is a flowchart of the authentication process of FIG. 1 according to an embodiment of the present disclosure.

Like reference symbols in the various drawings indicate like elements.

### DETAILED DESCRIPTION OF THE PREFERRED EMBODIMENTS

### System Overview

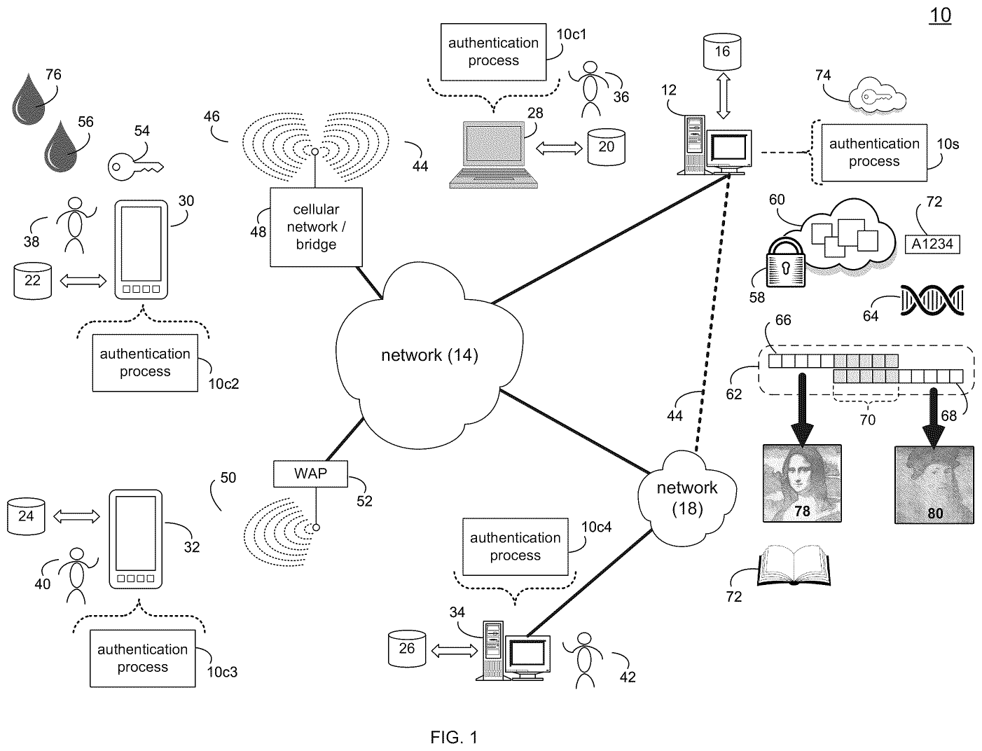

Referring to FIG. 1, there is shown authentication process 10. Authentication process 10 may be implemented as a server-side process, a client-side process, or a hybrid server-side/client-side process. For example, authentication process 10 may be implemented as a purely server-side process via authentication process 10s. Alternatively, authentication process 10 may be implemented as a purely client-side process via one or more of authentication process 10c1, authentication process 10c2, authentication process and authentication process 10c4. Alternatively still, authentication process 10 may be implemented as a hybrid server-side/client-side process via authentication process 10s in combination with one or more of authentication process 10c1, authentication process authentication process 10c3, and authentication process 10c4. Accordingly, authentication process 10 as used in this disclosure may include any combination of authentication process 10s, authentication process 10c1, authentication process 10c2, authentication process 10c3, and authentication process 10c4.

Authentication process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of authentication process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of authentication processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX platform). The instruction sets and subroutines of authentication processes 10c1, 10c2, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to a personal digital assistant (not shown), a tablet computer (not shown), laptop computer 28, smart phone 30, smart phone 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access authentication process 10 directly through network 14 or through secondary network 18. Further, authentication process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and smart phone 30 are shown wirelessly coupled to network 14 via wireless communication channels 44, 46 (respectively) established between laptop computer 28, smart phone 30 (respectively) and cellular network/bridge 48, which is shown directly coupled to network 14. Further, smart phone 32 is shown wirelessly coupled to network 14 via wireless communication channel 50 established between smart phone 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between smart phone 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

DeoxyriboNucleic Acid (DNA):

DNA stands for Deoxyribonucleic Acid, and it is a molecule that contains the genetic instructions for the development, functioning, growth, and reproduction of all known living organisms and many viruses. It serves as the blueprint or genetic code of life. DNA is made up of a long chain of nucleotides, which are the building blocks of the molecule. Each nucleotide consists of three components: a sugar molecule (deoxyribose), a phosphate group, and a nitrogenous base. There are four types of nitrogenous bases found in DNA: adenine (A), thymine (T), guanine (G), and cytosine (C).

The arrangement of these nitrogenous bases along the DNA strand forms the genetic code. Adenine always pairs with thymine (A-T), and guanine always pairs with cytosine (G-C). This pairing is known as base-pairing, and it is crucial for the process of DNA replication, where a cell duplicates its DNA during cell division to pass on genetic information to the daughter cells.

DNA is located inside the cell nucleus in eukaryotic cells (cells with a defined nucleus) and within the nucleoid region in prokaryotic cells (cells lacking a true nucleus). In addition to its role in inheritance and genetics, DNA also plays a fundamental role in protein synthesis through a process called transcription and translation.

RiboNucleic Acid (RNA):

RNA stands for Ribonucleic Acid, and it is a molecule that plays a crucial role in various cellular processes within living organisms. Like DNA, RNA is composed of nucleotides, but there are some key differences between the two molecules.

The structure of RNA is similar to DNA in that it is a single-stranded chain of nucleotides. Each nucleotide in RNA consists of three components: a sugar molecule (ribose), a phosphate group, and a nitrogenous base. However, RNA uses a slightly different set of nitrogenous bases compared to DNA. In RNA, the bases are adenine (A), uracil (U), guanine (G), and cytosine (C). Notably, thymine (T) is replaced by uracil (U) in RNA.

The primary types of RNA in cells include:
Messenger RNA (mRNA): This type of RNA carries genetic information from the DNA in the cell nucleus to the ribosomes in the cytoplasm. It serves as a template for protein synthesis during translation.
Transfer RNA (tRNA): tRNA molecules are responsible for bringing specific amino acids to the ribosomes during protein synthesis. Each tRNA has an anticodon sequence that pairs with the complementary codon on the mRNA.
Ribosomal RNA (rRNA): rRNA is a fundamental component of ribosomes, the cellular machinery responsible for protein synthesis. It helps in the catalysis of peptide bond formation during translation.

RNA plays a central role in the process of gene expression, where the genetic information encoded in DNA is used to create functional proteins. The process of gene expression involves two main steps: transcription and translation.

During transcription, RNA polymerase enzymes read the DNA sequence and synthesize a complementary mRNA strand, using the appropriate base pairing (A-U, G-C). This mRNA molecule then leaves the nucleus and enters the cytoplasm for translation.

During translation, the ribosomes read the sequence of codons on the mRNA, and with the help of tRNA molecules carrying the corresponding amino acids, they assemble the amino acids in the correct order to form a functional protein.

RNA also has other essential roles in various cellular processes, such as gene regulation, RNA splicing, and catalytic functions in certain enzymes (e.g., ribozymes). Overall, RNA plays a critical part in the flow of genetic information and the functioning of cells in living organisms.

DNA Profiling:

DNA can identify an individual through a process called DNA profiling or DNA fingerprinting. This technique relies on the uniqueness of an individual's DNA sequence, except in the case of identical twins, who have nearly identical DNA profiles. The main areas where DNA profiling is commonly used include forensic investigations, paternity testing, and identifying human remains.

The process of DNA profiling involves several steps:
DNA Sample Collection: The first step is to obtain a DNA sample from the individual in question. Common sources of DNA samples include blood, saliva, hair roots, buccal swabs (swabs from the inside of the cheek), and other bodily tissues or fluids.
DNA Extraction: The collected sample is subjected to DNA extraction, where the DNA is isolated from the rest of the cellular components. This step is necessary to obtain a pure DNA sample for analysis.
Polymerase Chain Reaction (PCR): PCR is used to amplify specific regions of the DNA known as short tandem repeats (STRs) or microsatellites. These regions are highly variable between individuals, and they are the key elements used for identification.
Electrophoresis: The amplified DNA fragments are then separated using a technique called gel electrophoresis. In this process, the DNA fragments are placed in a gel and subjected to an electric field, causing them to move through the gel at different rates based on their size.
DNA Analysis: After electrophoresis, the resulting DNA bands are visualized, and the sizes of the amplified DNA fragments are measured. These sizes represent the different alleles (variants) of the STRs.
DNA Profile: The measured sizes of the STR alleles for each individual are compiled to create a unique DNA profile or DNA fingerprint. The likelihood of two individuals having the same DNA profile is exceedingly low, making it a highly reliable method for individual identification.
Comparison: To identify an individual, their DNA profile is compared with DNA profiles from known individuals, such as suspects in a criminal investigation or potential parents in a paternity test.

Ironically, the vast majority of DNA is common among all humans. In fact, humans share approximately 99.9% of their DNA with each other. This means that only a tiny fraction of the DNA (about 0.1%) varies between individuals. This 0.1% variation is what gives rise to the unique genetic differences that make each person genetically distinct.

The areas of the genome that vary between individuals are typically found in regions known as single nucleotide polymorphisms (SNPs) and short tandem repeats (STRs). SNPs are single-nucleotide changes at specific positions in the DNA sequence, while STRs are regions with variable numbers of repeated DNA sequences.

The above-described DNA profile is based on the analysis of highly variable regions of the DNA known as short tandem repeats (STRs) or microsatellites. These regions contain repetitive sequences of nucleotides, and the number of repeats can vary significantly between individuals. The variability of STRs makes them excellent markers for individual identification because the likelihood of two unrelated individuals having the same DNA profile is extremely low.

Authentication Process

As will be discussed below in greater detail, there is shown authentication process 10 that may be configured to enable a user (e.g., user 38) to confirm their identity via a “key” (e.g., private key 54) that is based upon the unique genetic identifiers (e.g., genetic sequence sample 56) of e.g., user 38. Private key 54 may be configured to interface with a “lock” (e.g., public lock 58) that may be used to secure/protect various assets 60, examples of which may include but are not limited to a digital asset, a virtual asset and a physical asset).

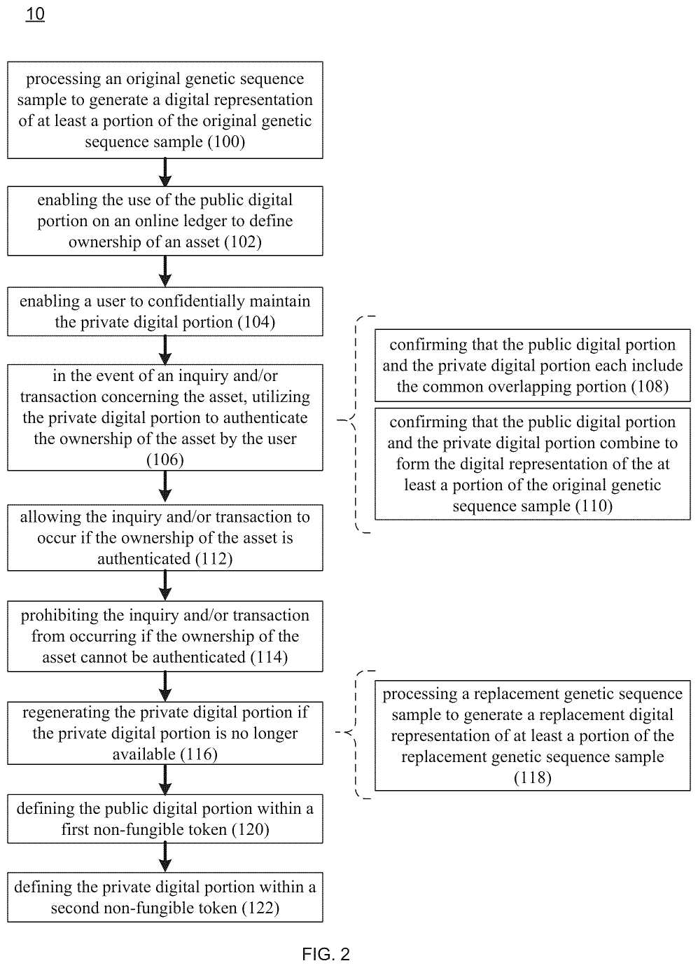

Referring also to FIG. 2, authentication process 10 may process 100 an original genetic sequence sample (e.g., genetic sequence sample 56) to generate a digital representation (e.g., digital representation 62) of at least a portion of the original genetic sequence sample (e.g., genetic sequence sample 56). This original genetic sequence sample (e.g., genetic sequence sample 56) may include one or more of: a DNA sample; and an RNA sample.

For example, assume that user 38 provides a DNA sample (e.g., genetic sequence sample 56) to a service provider (e.g., a DNA processing lab, not shown) for processing so that the above-described DNA profile (e.g., DNA profile 64) may be extracted. Once extracted, DNA profile 64 may be processed 100 to generate digital representation 62.

Accordingly, DNA profile 64 may be processed 100 by authentication process using one of more encoding algorithms to generate digital representation 62. Generally speaking, data encoding is the process of converting information or data (e.g., DNA profile 64) into a specific format or representation suitable for transmission, storage, or processing. Encoding ensures that data (e.g., DNA profile 64) can be accurately transmitted or stored, and it often involves converting data (e.g., DNA profile 64) into a series of binary digits (i.e., 0 s and 1 s) to create a digital representation (e.g., digital representation 62). There are various encoding methods depending on the type of data and its intended use. Some common data encoding techniques may include but are not limited to:
Binary Encoding: This method represents data using a series of binary digits (bits). Each bit can be either a 0 or a 1, and combinations of bits can represent different values. For example, ASCII (American Standard Code for Information Interchange) encoding is a widely used binary encoding scheme that represents characters and symbols as specific 7 or 8-bit binary codes.
Numeric Encoding: Numeric data, such as integers or floating-point numbers, can be encoded using binary representations that follow specific rules and formats. For example, the IEEE 754 standard is commonly used for encoding floating-point numbers.
Character Encoding: This encoding is used to represent characters, letters, and symbols in a digital format. Popular character encoding schemes include ASCII, Unicode, and UTF-8, which can represent characters from multiple languages and character sets.
Run-Length Encoding (RLE): RLE is a simple compression technique used to represent data that contains long sequences of the same value. Instead of repeating the same value multiple times, RLE stores the value and the number of repetitions, reducing the overall size of the encoded data.
Huffman Encoding: Huffman encoding is a variable-length encoding technique used for data compression. It assigns shorter binary codes to more frequently occurring data and longer codes to less frequent data, resulting in efficient compression.
Base64 Encoding: Base64 is a binary-to-text encoding scheme used to represent binary data (e.g., images, files) in an ASCII text format. It is commonly used for encoding binary data in email attachments or transmitting binary data over text-based protocols like HTTP.
Encryption: Encryption is a method of encoding data to protect it from unauthorized access. Encryption uses algorithms to scramble the data, making it unreadable without the proper decryption key.

The choice of encoding method depends on factors such as the type of data, the intended use of the data, the need for compression, and compatibility with different systems and protocols. Data encoding is a crucial aspect of modern computing and communication, enabling efficient data storage, transmission, and security.

The digital representation (e.g., digital representation 62) may include: public digital portion (e.g., public digital portion 66) and a private digital portion (e.g., private digital portion 68) that have a common overlapping portion (e.g., overlapping portion 70).

For example and when using authentication process 10, user 38 may submit a DNA sample (e.g., genetic sequence sample 56) to a service provider (e.g., a DNA processing lab, not shown) to generate DNA profile 64. User 38 may then submit DNA profile 64 to authentication process 10 so that DNA profile 64 may be processed 100 by authentication process 10 using one of more encoding algorithms to generate digital representation 62.

Specifically, authentically process 10 may ask user 38 to define a secure PIN number (e.g., PIN 72) so that DNA profile 64 may be processed 100. Once such a secure PIN number (e.g., PIN 72) is defined, the manner in which digital representation 62 is generated may also be defined. For example, authentically process 10 may select the encoding algorithm (not shown) from a plurality of available encoding algorithms (not shown) based upon the PIN chosen.

Additionally, the manner in which the digital representation (e.g., digital representation 62) is divided into public digital portion 66 and private digital portion 68 (as well as the width of overlapping portion 70) may all be based upon the secure PIN number (e.g., PIN 72) chosen by (in this example) user 38).

Generally speaking, public digital portion 66 is the identification information included within public lock 58, while private digital portion 68 is the identification information included within private key 54. As discussed above, encryption is a method of encoding data to protect it from unauthorized access, which uses algorithms to scramble the data (making it unreadable without the proper decryption key). Accordingly, one or both of public digital portion 66 and private digital portion 68 may be encoded to prevent such unauthorized access.

For example, authentication process 10 may enable 102 the use of the public digital portion (e.g., public digital portion 66) on an online ledger (e.g., online ledger 72) to define ownership of an asset (e.g., one or more of assets 60). Examples of the online ledger (e.g., online ledger 72) may include but is not limited to a distributed blockchain ledger.

A blockchain ledger is a distributed and decentralized digital record-keeping system that securely and transparently maintains a chronological sequence of transactions or data across multiple computers or nodes. It is the underlying technology behind cryptocurrencies like Bitcoin, but its applications go beyond digital currencies.

In a traditional centralized ledger system, a single entity (like a bank or a government authority) is responsible for maintaining and validating all transactions or data. However, in a blockchain ledger, this responsibility is distributed among a network of participants, each having a copy of the entire ledger.

Key characteristics of a blockchain ledger include:
Decentralization: There is no central authority controlling the entire ledger. Instead, it is maintained by a network of independent nodes, each having a copy of the entire ledger.
Security: Blockchains use advanced cryptographic techniques to ensure the integrity and security of the data. Once a block of transactions is added to the blockchain, it becomes nearly impossible to alter or tamper with the data.
Immutability: Once data is recorded on the blockchain, it cannot be deleted or modified. Each block contains a reference to the previous block, creating a chain of blocks, hence the name “blockchain.”
Consensus Mechanism: In a decentralized environment, there needs to be a mechanism for reaching a consensus among participants about the validity of transactions and the order in which they are recorded. Different blockchain networks use various consensus mechanisms, such as Proof-of-Work (PoW) or Proof-of-Stake (PoS).
Transparency: The blockchain ledger is publicly accessible, allowing anyone to view and verify the transactions. This transparency enhances trust and accountability.
Smart Contracts: Some blockchain platforms, like Ethereum, support smart contracts, which are self-executing contracts with the terms of the agreement directly written into the code. Smart contracts automatically execute when predefined conditions are met.

Blockchain ledgers find applications in various industries beyond cryptocurrencies. They are used for supply chain management, voting systems, identity verification, healthcare records, intellectual property rights, real estate transactions, and more. The decentralized and transparent nature of blockchain ledgers addresses issues of trust, security, and data integrity in numerous domains.

The asset (e.g., assets 60) may include one or more of: a digital asset, a virtual asset, and a physical asset, wherein:
a digital asset refers to any form of data or content that has economic value and can be owned, exchanged, or traded in a digital format. These assets exist solely in digital form and are typically stored and accessed through electronic devices and computer networks. Digital assets encompass a wide range of items, from cryptocurrencies and digital tokens to digital media, software, intellectual property, and more. Here are some common types of digital assets:
   1. Cryptocurrencies: Digital currencies like Bitcoin, Ethereum, and many others are considered digital assets. They use blockchain technology to secure transactions, maintain ownership records, and enable peer-to-peer transfers without the need for intermediaries like banks.
   2. Digital Tokens: These are digital assets that represent ownership of an underlying asset or utility within a specific blockchain ecosystem. Tokens are commonly used in Initial Coin Offerings (ICOs) and various decentralized applications (dApps).
   3. Digital Media: Digital assets also include various forms of digital media, such as images, videos, music, e-books, and other multimedia content. These assets are commonly distributed and consumed online.
   4. Software and Applications: Computer software, mobile applications, and digital programs are also considered digital assets. They can be licensed or sold to users for their use and benefit.
   5. Domain Names: Domain names used for websites are digital assets that can be bought, sold, or transferred between owners.
   6. Intellectual Property: Digital assets can include copyrighted content, patents, trademarks, and other forms of intellectual property that hold economic value.
   7. Digital Art and NFTs: Non-fungible tokens (NFTs) are a special type of digital asset representing unique digital items, such as digital art, collectibles, and virtual real estate. NFTs are often used to establish ownership and provenance of digital creations.
   8. Digital Records and Data: Digital assets can also include records, databases, and other digital data that hold value, such as customer information, financial records, and scientific research data.

The value of digital assets can vary widely depending on factors like demand, scarcity, usefulness, and uniqueness. The rise of blockchain technology and smart contracts has enabled new ways to tokenize and manage digital assets securely and transparently. Digital assets have become an important part of the modern digital economy, facilitating new forms of ownership, transactions, and creative expression.
a virtual asset refers to any digital or intangible item with value that exists in a virtual or digital environment but lacks physical presence. These assets are entirely electronic and exist only in cyberspace or virtual worlds. They are distinct from physical assets and are often used in online gaming, virtual economies, and digital platforms. Here are some examples of virtual assets:
   1. Virtual Currencies: Cryptocurrencies, such as Bitcoin, Ethereum, and many others, are a type of virtual asset. They are digital currencies that exist only in electronic form and are used for online transactions and value exchange.
   2. Virtual Goods: In online gaming and virtual worlds, virtual goods are items, accessories, skins, or other digital assets that players can acquire, own, and use within the game or virtual environment. These goods may enhance the gameplay or represent status or achievements.
   3. Non-Fungible Tokens (NFTs): NFTs are unique digital assets that represent ownership of specific digital items, such as digital art, collectibles, virtual real estate, or virtual pets. NFTs use blockchain technology to establish ownership and authenticity.
   4. Digital Content: Virtual assets can include digital content such as e-books, digital music, movies, virtual event tickets, and digital subscriptions.
   5. Virtual Land and Property: Some virtual worlds or metaverses offer virtual land and property that users can own, develop, and trade.
   6. Virtual Currency within Online Games: Some online games have their in-game currencies or tokens that players can earn, purchase, or trade.

Virtual assets often have value within their respective digital ecosystems and can be bought, sold, traded, or exchanged for other virtual assets or real-world currencies. The ownership and transfer of virtual assets are facilitated by digital platforms and blockchain technology in the case of NFTs.

Virtual assets have gained significant popularity due to the growth of online gaming, virtual economies, and the emergence of blockchain-based digital assets. However, it's important to note that virtual assets can have limited or restricted convertibility into real-world assets, and their value may be subject to fluctuations based on market demand and the rules set by the platforms governing their usage.
a physical asset refers to a tangible, material item or property with intrinsic value that has a physical presence and can be physically touched or seen. These assets have a physical existence and can be used, owned, bought, sold, or rented by individuals, businesses, or organizations. Physical assets play a vital role in the economy and can be essential for the production of goods and services. Examples of physical assets include:
   1. Real Estate: Physical properties such as land, buildings, houses, apartments, and commercial spaces are considered physical assets. Real estate can be used for residential, commercial, industrial, or agricultural purposes.
   2. Machinery and Equipment: Physical assets like machinery, vehicles, factory equipment, computers, and tools are used in various industries and businesses to produce goods or provide services.
   3. Infrastructure: Physical assets include public infrastructure like roads, bridges, highways, airports, railways, and utilities such as water supply and electricity grids.
   4. Inventory: Physical goods held by businesses for sale or manufacturing are considered physical assets. This includes raw materials, work-in-progress, and finished goods.
   5. Precious Metals and Commodities: Assets like gold, silver, platinum, copper, and other precious metals are physical assets with intrinsic value. Additionally, commodities such as oil, natural gas, agricultural products, and metals are also physical assets.
   6. Art and Collectibles: Valuable artworks, antiques, rare collectibles, and historical artifacts are considered physical assets.
   7. Livestock and Agricultural Land: Livestock, crops, and agricultural land are physical assets used in farming and agriculture.

Physical assets are essential for economic growth and contribute to the overall wealth and prosperity of individuals and nations. They can be bought, sold, leased, or used as collateral to secure loans or financing. Proper management and maintenance of physical assets are crucial to ensure their longevity, value, and efficient utilization.

In contrast, financial assets, such as stocks, bonds, and derivatives, are not tangible physical items but represent ownership or claims on the underlying assets or future cash flows. Physical assets, being tangible and concrete, have a more direct and immediate impact on various aspects of the economy and everyday life.

Accordingly, if user 38 (e.g., John Smith) owned 1,000 bitcoins, online ledger (e.g., online ledger 72) may be utilized by user 38 to record/memorialize the ownership of such 1,000 bitcoins. Additionally, authentication process 10 may enable 102 the use of public digital portion 66 within online ledger 72 to define ownership such 1,000 bitcoins. Accordingly, public digital portion 66 (i.e., the public lock) may be associated with/included within/appended to the block (not shown) within the blockchain (not shown) that defines the ownership of such 1,000 bitcoins. Therefore, in the event that an attempt is made to e.g., change the ownership of such 1,000 bitcoins, the use of public digital portion 66 (i.e., the public lock) with the block (not shown) of the blockchain (not shown) that defines the ownership of such 1,000 bitcoins would require the use of private digital portion 68 (e.g., the private key) to effectuate the same.

Authentication process 10 may enable 104 a user (e.g., a user 38) to confidentially maintain the private digital portion (e.g., private digital portion 68). For example, private digital portion 68 may be confidentially maintained within e.g., smart phone 30 used by user 38. Additionally/alternatively, private digital portion 68 may be confidentially maintained within e.g., secure storage 74 maintained/controlled by authentication process 10.

In the event of an inquiry and/or transaction concerning the asset (e.g., the 1,000 bitcoins), authentication process 10 may utilize 106 the private digital portion (e.g., private digital portion 68) to authenticate the ownership of the asset (e.g., the 1,000 bitcoins) by the user (e.g., a user 38). For example, if there is an attempt to transfer the ownership of the asset (e.g., the 1,000 bitcoins) from the owner (e.g., a user 38) to a third party (e.g., user authentication process 10 may utilize 106 (e.g., require) the private digital portion (e.g., private digital portion 68) to authenticate the ownership of the asset (e.g., the 1,000 bitcoins) by the owner (e.g., a user 38).

Accordingly, authentication process 10 may require that a copy of the private digital portion (e.g., private digital portion 68) be provided to authentication process 10 from the owner (e.g., a user 38) to authenticate the ownership of the asset (e.g., the 1,000 bitcoins) by the owner (e.g., a user 38). Additionally/alternatively and upon receiving a copy of the private digital portion (e.g., private digital portion 68), authentication process may contact the owner (e.g., a user 38) via two factor authentication such as Microsoft Authenticator to confirm that the owner (e.g., a user 38) is aware of and/or authorizes the subject transaction.

For example and when utilizing 106 the private digital portion (e.g., private digital portion 68) to authenticate the ownership of the asset (e.g., the 1,000 bitcoins) by the user (e.g., a user 38), authentication process 10 may confirm 108 that the public digital portion (e.g., public digital portion 66) and the private digital portion (e.g., private digital portion 68) each include the common overlapping portion (e.g., overlapping portion 70).

For example and when authenticating the ownership of the asset (e.g., the 1,000 bitcoins) by user 38, authentication process 10 may examine public digital portion 66 and private digital portion 68 to confirm 108 that public digital portion 66 includes overlapping portion 70 (e.g., the last half of public digital portion 66; shown in grey) and that private digital portion 68 includes overlapping portion 70 (e.g., the first half of private digital portion 68; shown in grey).

Further and when utilizing 106 the private digital portion (e.g., private digital portion 68) to authenticate the ownership of the asset (e.g., the 1,000 bitcoins) by the user (e.g., a user 38), authentication process 10 may confirm 110 that the public digital portion (e.g., public digital portion 66) and the private digital portion (e.g., private digital portion 68) combine to form the digital representation (e.g., digital representation 62) of the at least a portion of the original genetic sequence sample (e.g., genetic sequence sample 56).

For example and when authenticating the ownership of the asset (e.g., the 1,000 bitcoins) by user 38, authentication process 10 may examine public digital portion 66 and private digital portion 68 to confirm 110 that public digital portion 66 and private digital portion 68 (when combined) completely form digital representation 62 (with it understood that the combination of public digital portion 66 and private digital portion 68 will include two copies of overlapping portion 70; shown in grey.

Continuing the above-described example in which there is an attempt to transfer the ownership of the asset (e.g., the 1,000 bitcoins) from the owner (e.g., a user 38) to a third party (e.g., user 40), authentication process 10 may: allow 112 the inquiry and/or transaction to occur if the ownership of the asset (e.g., the 1,000 bitcoins) is authenticated; and may prohibit 114 the inquiry and/or transaction from occurring if the ownership of the asset (e.g., the 1,000 bitcoins) cannot be authenticated.

For example and generally speaking, when there is an attempt to transfer the ownership of the asset (e.g., the 1,000 bitcoins) from the owner (e.g., user 38) to a third party (e.g., user 40), authentication process 10 may determine if private digital portion 68 (e.g., the private key) associated with/included within/appended to the block (not shown) within the blockchain (not shown) that defines the ownership of such 1,000 bitcoins is available to unlock the public digital portion 66 (e.g., the public lock). If so, authentication process 10 may allow 112 the inquiry and/or transaction to occur; and, if not, authentication process 10 may prohibit 114 the inquiry and/or transaction from occurring.

As private digital portion 68 (e.g., the private key) is generated using genetic sequence sample 56 (in this example, a sample of a DNA of user 38), authentication process may regenerate 116 the private digital portion if the private digital portion (e.g., private digital portion 68) is no longer available. For example, if user 38 loses smart phone 30) and/or secure storage 74 maintained/controlled by authentication process 10 is corrupted/damaged, authentication process 10 may regenerate 116 private digital portion 68.

Specifically and when regenerating 116 the private digital portion (e.g., digital portion 68) if the private digital portion (e.g., digital portion 68) is no longer available, authentication process 10 may process 118 a replacement genetic sequence sample (e.g., replacement genetic sequence sample 76) to generate a replacement digital representation of at least a portion of the replacement genetic sequence sample (e.g., replacement genetic sequence sample 76). This replacement digital representation includes: public digital portion 66 and private digital portion 68 since the replacement genetic sequence sample (e.g., replacement genetic sequence sample 76) is generated using the same processes as the original genetic sequence sample (e.g., genetic sequence sample 56).

Non-Fungible Tokens

A non-fungible token (NFT) is a unique digital asset that represents ownership or proof of authenticity for a specific item or piece of content in a digital format. Unlike cryptocurrencies like Bitcoin or Ethereum, which are fungible and can be exchanged on a one-to-one basis, NFTs are non-fungible, meaning each token has distinct properties and cannot be replaced or exchanged on a like-for-like basis.

Key characteristics of non-fungible tokens include:
Uniqueness: Each NFT is one-of-a-kind and has a unique identifier that sets it apart from all other tokens. This uniqueness is often used to represent ownership of a particular digital item, artwork, collectible, virtual real estate, or any other digital asset.
Indivisibility: NFTs cannot be divided into smaller units like cryptocurrencies. They are indivisible and represent the whole ownership of the specific digital asset they are associated with.
Proof of Authenticity: NFTs are built on blockchain technology, typically using standards like ERC-721 or ERC-1155 on the Ethereum blockchain. This blockchain-based nature ensures a secure and immutable record of ownership and provenance for the digital asset.
Ownership and Transfer: NFTs allow users to buy, sell, and transfer ownership of the associated digital asset in a decentralized manner. Ownership transfers are recorded on the blockchain, ensuring transparency and trust.

NFTs have gained significant attention and popularity in the art, gaming, entertainment, and collectibles industries. They have enabled a new way for digital artists and creators to tokenize and sell their work directly to collectors, with provenance and ownership secured through blockchain technology. In gaming, NFTs are used to represent unique in-game items or virtual land, allowing players to truly own and trade their digital possessions.

The value of NFTs is determined by factors such as scarcity, desirability, provenance, and the reputation of the creator or artist. Some NFTs have sold for substantial amounts in online auctions, making headlines in the mainstream media.

Authentication process 10 may define 120 the public digital portion (e.g., public digital portion 66) within a first non-fungible token (e.g., first non-fungible token 78). For example, authentication process 10 may embed public digital portion 66 within first non-fungible token 78. Further, public digital portion 66 may be encrypted prior to being defined 120 within first non-fungible token 78, thus allowing for public digital portion 66 to be visible within first non-fungible token 78 . . . but not understandable without the appropriate decryption key (which may be maintained in confidence within secure storage 74 by authentication process 10).

Accordingly and in such a configuration, first non-fungible token 78 may be utilized by user 38 as an avatar, thus associating a visual image with their identity. Further and in such a configuration, user 38 may be able to set up multiple identities by generating multiple public digital portions, thus allowing user 38 to have multiple online personas. For example, a business online persona of user 38 may be a first non-fungible token of the Mona Lisa with a yellow background, while a personal online persona of user 38 may be a first non-fungible token of the Mona Lisa with a blue background.

Authentication process 10 may define 122 the private digital portion (e.g., private digital portion 68) within a second non-fungible token (e.g., second non-fungible token 80). For example, authentication process 10 may embed private digital portion 68 within second non-fungible token 80. Further, private digital portion 68 may be encrypted prior to being defined 112 within second non-fungible token 80, thus allowing for private digital portion 68 to be visible within second non-fungible token 80 . . . but not understandable without the appropriate decryption key (which may be maintained in confidence within secure storage 74 by authentication process 10).

Accordingly and in such a configuration, second non-fungible token 80 may be utilized by user 38 as an avatar, thus associating a visual image with their identity. Further and in such a configuration, user 38 may be able to set up multiple identities by generating multiple private digital portions, thus allowing user 38 to have multiple online personas. For example, a business online persona of user 38 may be a second non-fungible token of the Leonardo diVinci with a yellow background, while a personal online persona of user 38 may be a second non-fungible token of the Leonardo diVinci with a blue background.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing an original genetic sequence sample to generate a digital representation of at least a portion of the original genetic sequence sample, wherein the digital representation includes: a public digital portion and a private digital portion that have a common overlapping portion;
enabling the use of the public digital portion on an online ledger to define ownership of an asset; and
enabling a user to confidentially maintain the private digital portion.

2. The computer-implemented method of claim 1 further comprising:
in the event of an inquiry and/or transaction concerning the asset, utilizing the private digital portion to authenticate the ownership of the asset by the user.

3. The computer-implemented method of claim 2 wherein utilizing the private digital portion to authenticate the ownership of the asset by the user includes one or more of:
confirming that the public digital portion and the private digital portion each include the common overlapping portion; and
confirming that the public digital portion and the private digital portion combine to form the digital representation of the at least a portion of the original genetic sequence sample.

4. The computer-implemented method of claim 2 further comprising:
allowing the inquiry and/or transaction to occur if the ownership of the asset is authenticated.

5. The computer-implemented method of claim 2 further comprising:
prohibiting the inquiry and/or transaction from occurring if the ownership of the asset cannot be authenticated.

6. The computer-implemented method of claim 1 further comprising one or more of:
defining the public digital portion within a first non-fungible token; and
defining the private digital portion within a second non-fungible token.

7. The computer-implemented method of claim 1 wherein the online ledger includes a distributed blockchain ledger.

8. The computer-implemented method of claim 1 wherein the asset includes one or more of:
a digital asset;
a virtual asset; and
a physical asset.

9. The computer-implemented method of claim 1 further comprising:
regenerating the private digital portion if the private digital portion is no longer available.

10. The computer-implemented method of claim 9 wherein regenerating the private digital portion if the private digital portion is no longer available includes:
processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample.

11. The computer-implemented method of claim 1 wherein the original genetic sequence sample includes one or more of:
a DNA sample; and
an RNA sample.

12. The computer-implemented method of claim 11 wherein the DNA sample includes one or more of:
a real DNA sample;
a synthetic DNA sample; and
an imaginary DNA sample.

13. A computer program product residing on a computer readable medium having a plurality of instructions stored thereon which, when executed by a processor, cause the processor to perform operations comprising:
processing an original genetic sequence sample to generate a digital representation of at least a portion of the original genetic sequence sample, wherein the digital representation includes: a public digital portion and a private digital portion that have a common overlapping portion;
enabling the use of the public digital portion on an online ledger to define ownership of an asset; and
enabling a user to confidentially maintain the private digital portion.

14. The computer program product of claim 13 further comprising:
in the event of an inquiry and/or transaction concerning the asset, utilizing the private digital portion to authenticate the ownership of the asset by the user.

15. The computer program product of claim 14 wherein utilizing the private digital portion to authenticate the ownership of the asset by the user includes one or more of:
confirming that the public digital portion and the private digital portion each include the common overlapping portion; and
confirming that the public digital portion and the private digital portion combine to form the digital representation of the at least a portion of the original genetic sequence sample.

16. The computer program product of claim 14 further comprising:
allowing the inquiry and/or transaction to occur if the ownership of the asset is authenticated.

17. The computer program product of claim 14 further comprising:
prohibiting the inquiry and/or transaction from occurring if the ownership of the asset cannot be authenticated.

18. The computer program product of claim 13 further comprising one or more of:
defining the public digital portion within a first non-fungible token; and
defining the private digital portion within a second non-fungible token.

19. The computer program product of claim 13 wherein the online ledger includes a distributed blockchain ledger.

20. The computer program product of claim 13 wherein the asset includes one or more of:
a digital asset;
a virtual asset; and
a physical asset.

21. The computer program product of claim 13 further comprising:
regenerating the private digital portion if the private digital portion is no longer available.

22. The computer program product of claim 21 wherein regenerating the private digital portion if the private digital portion is no longer available includes:
processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample.

23. The computer program product of claim 13 wherein the original genetic sequence sample includes one or more of:
a DNA sample; and
an RNA sample.

24. The computer program product of claim 23 wherein the DNA sample includes one or more of:
a real DNA sample;
a synthetic DNA sample; and
an imaginary DNA sample.

25. A computing system including a processor and memory configured to perform operations comprising:
processing an original genetic sequence sample to generate a digital representation of at least a portion of the original genetic sequence sample, wherein the digital representation includes: a public digital portion and a private digital portion that have a common overlapping portion;
enabling the use of the public digital portion on an online ledger to define ownership of an asset; and
enabling a user to confidentially maintain the private digital portion.

26. The computing system of claim 25 further comprising:
in the event of an inquiry and/or transaction concerning the asset, utilizing the private digital portion to authenticate the ownership of the asset by the user.

27. The computing system of claim 26 wherein utilizing the private digital portion to authenticate the ownership of the asset by the user includes one or more of:
confirming that the public digital portion and the private digital portion each include the common overlapping portion; and
confirming that the public digital portion and the private digital portion combine to form the digital representation of the at least a portion of the original genetic sequence sample.

28. The computing system of claim 26 further comprising:
allowing the inquiry and/or transaction to occur if the ownership of the asset is authenticated.

29. The computing system of claim 26 further comprising:
prohibiting the inquiry and/or transaction from occurring if the ownership of the asset cannot be authenticated.

30. The computing system of claim 25 further comprising one or more of:
defining the public digital portion within a first non-fungible token; and
defining the private digital portion within a second non-fungible token.

31. The computing system of claim 25 wherein the online ledger includes a distributed blockchain ledger.

32. The computing system of claim 25 wherein the asset includes one or more of:
a digital asset;
a virtual asset; and
a physical asset.

33. The computing system of claim 25 further comprising:
regenerating the private digital portion if the private digital portion is no longer available.

34. The computing system of claim 33 wherein regenerating the private digital portion if the private digital portion is no longer available includes:
processing a replacement genetic sequence sample to generate a replacement digital representation of at least a portion of the replacement genetic sequence sample, wherein the replacement digital representation includes: the public digital portion and the private digital portion since the replacement genetic sequence sample is generated using the same processes as the original genetic sequence sample.

35. The computing system of claim 25 wherein the original genetic sequence sample includes one or more of:
a DNA sample; and
an RNA sample.

36. The computing system of claim 35 wherein the DNA sample includes one or more of:
a real DNA sample;
a synthetic DNA sample; and
an imaginary DNA sample.
